(19) United States
(12) Patent Application Publication
(10) Pub. No.: US 2024/0114907 A1
(43) Pub. Date: Apr. 11, 2024

(54) STABILIZED CONAZOLE COMPOSITION

(71) Applicants: UPL CORPORATION LIMITED, Port Louis (MU); UPL EUROPE LTD, Warrington (GB)

(72) Inventors: Masha Wine Sylvia BOS, Port Louis (MU); Jeroen SMIDT, Port Louis (MU); Alexander Cornelis Van Der LAAN, Port Louis (MU); Paymaneh Yousefzadeh Faal DEGHATI, Port Louis (MU)

(21) Appl. No.: 17/769,195

(22) PCT Filed: Oct. 15, 2020
(86) PCT No.: PCT/IB2020/059677

§ 371 Date: Apr. 14, 2022

(30) Foreign Application Priority Data
Oct. 15, 2019 (IN) 201921041767

(51) Int. Cl. A01N 43/50; A01N 25/22; A01P 3/00

(52) U.S. Cl. CPC A01N 43/50; A01N 25/22; A01P 3/00

(57) ABSTRACT

The present invention relates to a composition. The present invention more particularly relates to an improved composition capable of controlling phyto-pathogenic fungi on plants and to a method of controlling such fungi on plants.

### CROSS REFERENCE TO RELATED APPLICATIONS

This application is a National Stage application of PCT/M2020/059677, filed Oct. 15, 2020, which claims priority to Indian Patent Application No. 201921041767, filed Oct. 15, 2019, both of which are incorporated by reference in their entirety herein.

### FIELD OF THE INVENTION

The present invention relates to a composition. The present invention more particularly relates to an improved composition capable of controlling phyto-pathogenic fungi on plants and to a method of controlling such fungi on plants.

### BACKGROUND OF THE INVENTION

The protection of plants from plant diseases which cause great and irreparable loss, damage, harm and injury to plants is essential for healthy growth of the plant and enhancement of agricultural produce. Most crops and agricultural produce are subject to attack by several fungi. Fungal infestations cause significant yield reduction. Therefore, preventing and treating fungal infestations of plants and plant parts is crucial to obtain high productivity and is a continuing objective in the agricultural field. Particularly, Septoria spp., Puccinia recondite, Pucciniastriiformis, Pucciniagraminis, Erysiphegraminis, Drechsleramaydis, Leveillula Taurica, Venturiain equalis are pathogens causing significant yield losses of cereals, vegetables and fruits.

Fungicides are specific types of agrochemicals that are used widely to control fungal diseases by inhibiting or killing the fungus causing the diseases.

1,2,4-triazole and its derivatives represent one of the most biologically active classes of compounds, possessing a wide spectrum of activities. 1,2,4-triazole fungicides exhibit their antifungal activity by inhibiting C14-demethylase (P450 enzyme), a well-known target for fungicides. Either as single heterocyclic derivatives or in fusion with the other cycles, 1,2,4-triazoles have emerged as one of the most explored fungicides to obtain agrochemically significant compounds. 1,2,4-triazole fungicides are economically important agrochemicals as they are widely used on crops such as wheat, barley, soybean and orchard fruits and have protective, curative and eradicant properties.

A triazole fungicide of particular importance is 2-[2-(l-chlorocyclopropyl)-3-(2-chlorophen-yl)-2-hydroxypropyl]-2, 4-dihydro-[1,2,4-]-trazole-3-thione (prothioconazole).

Prothioconazole is a sterol demethylation (ergosterol biosynthesis) inhibitor and is used in agriculture as a fungicide. Various liquid and solid compositions of priothioconazole are available in the market. Prothioconazole is also formulated with other active ingredients in order to control a wider spectrum of pests, or to utilize multiple modes of action, compared to the individual active ingredient alone. When prothioconazole is combined with another active ingredient in the form of solid or liquid compositions, formulators face issues in developing a composition which remains stable over the period as well as it performs well in the field. Therefore, present invention relates to a stable formulation of prothioconazole having high performance as well as greater storage stability.

### SUMMARY

It is an objective of the present invention to provide an improved composition of conazole fungicides.

It is another objective of the present invention to provide a composition of conazole fungicides which is stable even at low concentration of conazole fungicide.

It is yet another objective of the present invention to provide compositions of conazole fungicides which are bio-efficacious.

In an aspect of the present invention, there is provided a composition comprising: a) at least one complexed conazole fungicide; and b) at least one de-complexing agent; wherein the de-complexing agent is selected from polymeric surfactants, chelating agents, inorganic and organic salts, amino acids and peptides, wherein said amino acids and peptides do not contain sulphur.

In an aspect of the present invention, there is provided a composition comprising: a) at least one complexed conazole fungicide, b) one or more agrochemical ingredients; and c) at least one de-complexing agent; wherein the de-complexing agent is selected from polymeric surfactants, chelating agents, inorganic and organic salts, amino acids and peptides, wherein said amino acids and peptides do not contain sulphur. In another aspect of the present invention, there is provided a process for producing a composition comprising (a) at least one complexed conazole fungicide; and (b) at least one de-complexing agent selected from polymeric surfactants, chelating agents, inorganic and organic salts, amino acids and peptides, wherein said amino acids and peptides do not contain sulphur; and wherein said process comprises: a) mixing at least one complexed conazole fungicide and at least one de-complexing agent to obtain the composition.

In further aspect of the present invention, there is provided a method of controlling unwanted pests, said method comprising applying an effective amount of a composition comprising (a) at least one complexed conazole fungicide; and (b) at least one de-complexing agent selected from polymeric surfactants, chelating agents, inorganic and organic salts, amino acids and peptides, wherein said amino acids and peptides do not contain sulphur, to the pests or to their habitat.

In further aspect of the present invention, there is provided a method of controlling unwanted pests, said method comprising applying an effective amount of a composition comprising (a) at least one complexed conazole fungicide; (b) one or more agrochemical ingredients and; (c) at least one de-complexing agent selected from polymeric surfactants, chelating agents, inorganic and organic salts, amino acids and peptides, wherein said amino acids and peptides do not contain sulphur, to the pests or to their habitat.

In an aspect of the present invention, there is provided a kit of a composition comprising: a) at least one complexed conazole fungicide; b) at least one de-complexing agent; wherein the de-complexing agent is selected from polymeric surfactants, chelating agents, inorganic and organic salts, amino acids and peptides, wherein said amino acids and peptides do not contain sulphur.

In an aspect of the present invention, there is provided a composition comprising at least one complexed conazole fungicide; and at least one de-complexing agent selected from polymeric surfactants, chelating agents, inorganic and organic salts, amino acids and peptides, wherein said amino acids and peptides do not contain sulphur, wherein said improved composition is used as pesticide.

### BRIEF DESCRIPTION OF THE DRAWINGS

FIG. 1 shows the degree of fungus damage (preventative effect) observed when fungus was treated with composition of Example 3 having a decomplexing agent prepared according to the present disclosure compared with the efficacy of the tank-mix preparation wherein prothioconazole is not existing in the complexed form.

FIG. 2 shows the control of fungus (curative effect) observed when fungus was treated with composition of example 3 prepared according to the present disclosure wherein comparatively lower control was observed with the composition of example 6 prepared without de-complexing agent.

### DETAILED DESCRIPTION OF THE INVENTION

It is known that certain conazole fungicides tend to degrade when present in low concentration in the composition. It becomes necessary to control the degradation issue with respect to conazole fungicides prior to making a composition wherein a conazole fungicide is present as an active ingredient in the composition at a low concentration.

Typical stabilizers, such as transition metal salts, are known to control the degradation of conazole fungicides when conazole fungicides are incorporated in low concentrations in the agrochemical composition. Conazole fungicides form stable complexes when surrounded by metal ions, which in turn prevents degradation. Therefore, conazole fungicides are first allowed to complex with metal ions to form a complexed conazole fungicide and such complexed conazole fungicide is incorporated as an active ingredient in the composition. However, it has been noted that during application of these composition to the pests or to their locus, these complexes do not break easily and hence a low or ineffective activity was observed due to lack of complete availability of conazole fungicide. One such example is prothioconazole.

Surprisingly, the inventors of the present invention found that a stable composition of such complexed prothioconazole can be prepared by incorporating a de-complexing agent.

In an embodiment, the de-complexing agent facilitates breaking of a prothioconazole-stabilizer complex and free prothioconazole can be made available for its activity.

With respect to the present invention, the term ‘a composition’ wherever used herein refers to a composition which facilitates availability of prothioconazole completely when applied to the pests or to their habitat as fungicide.

With respect to the present invention, the term ‘availability’ as used herein refers to an effective amount of prothioconazole ultimately available to the pests or to their habitat as fungicide.

With respect to the present invention, the term ‘complexed conazole’ as used herein refers to conazole fungicide in cohesion with the stabilizer forming a complex. In some embodiments, the invention provides a composition of complexed conazole fungicide.

In some embodiment, the complexed conazole fungicide comprises a conazole fungicide complexed with a stabilizer. Therefore, present invention comprises a composition of a conazole fungicide wherein the conazole fungicide is first stabilized by complexing it with a stabilizer.

In some other embodiments, the invention provides a composition of complexed conazole fungicide wherein de-complexing agent facilitates free conazole availability for its biological action on pests or to their locus.

Therefore, in an embodiment, the present invention provides the use of a decomplexing agent for improving the bioavailability of a complexed conazole fungicide.

Accordingly, in an embodiment of the present invention, there is provided a composition comprising:
(a) at least one complexed conazole fungicide; and
(b) at least one de-complexing agent; wherein the de-complexing agent is selected from polymeric surfactants, chelating agents, inorganic and organic salts, amino acids and peptides, wherein said amino acids and peptides do not contain sulphur.

According to an embodiment of the present invention, conazole fungicide is selected from the group comprising triazole fungicides and imidazole fungicides, their salts, or esters, or isomers or derivatives thereof.

According to an embodiment of the present invention, triazole fungicides are selected from the group comprising azaconazole, bromuconazole, cyproconazole, diclobutrazol, difenoconazole, diniconazole, diniconazole-M, epoxiconazole, etaconazole, fenbuconazole, fluconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, thiabendazole (triazole), triadimefon, triadimenol, triticonazole, uniconazole and uniconazole-P, their salts, or esters, or isomers or derivatives thereof.

According to an embodiment of the present invention, imidazole fungicides are selected from the group comprising climbazole, clotrimazole, imazalil, oxpoconazole, prochloraz and triflumizole, their salts, or esters, or isomers or derivatives thereof.

According to the preferred embodiment of the present invention, conazole fungicides are selected from prothioconazole, cyproconazole, hexaconazole and tebuconazole, their salts, or esters, or isomers or derivatives thereof.

According to the most preferred embodiment of the present invention, the conazole fungicide is prothioconazole ((2-(2-(1-chlorocyclopropyl)-3-(2-chlorophenyl)-2-hydroxypropyl)-1,2-dihydro-3H1,2,4-triazole-3-thione), their salts, or esters, or isomers or derivatives thereof.

In an embodiment of the present invention, the improved composition comprises from about 0.01% to about 40% w/w and preferably from about 0.1% to about 30% w/w conazole fungicide of the total weight of the high performing composition.

In a preferred embodiment of the present invention, the improved composition comprises from about 1% to about 20% w/w conazole fungicide of the total weight of the high performing composition.

According to an embodiment of the present invention, the improved composition comprises a complexed conazole fungicide.

According to an embodiment of the present invention, the improved composition comprises a complexed conazole fungicide wherein the conazole is complexed with a stabilizer.

According to an embodiment of the present invention, the stabilizer is the salt of transition metals including nitrates, carbonates, sulfates, halides and hydroxides wherein the transition metals are either in monovalent, divalent or trivalent state. According to an embodiment of the present invention, the stabilizer is the transition metal salt selected from but not limited to copper nitrate, cuprous nitrate, copper nitrite, cuprous sulfite, cupric sulfite, copper sulfate, copper carbonate, copper chloride, cuprous chloride, copper bromide, copper iodide, copper fluoride, copper hydroxide, ferric nitrate, ferrous nitrate, ferric nitrite, ferrous nitrite, ferric carbonate, ferric chloride, ferrous chloride, ferric bromide, ferric iodide, ferric fluoride, ferric hydroxide, zinc nitrate, zinc nitrite, zinc sulfate, zinc sulfite, zinc carbonate, zinc chloride, zinc bromide, zinc iodide, zinc fluoride, zinc hydroxide, manganese nitrate, manganese nitrite, manganese sulfite, manganese sulfate, manganese carbonate, manganese chloride, manganese bromide, manganese iodide, manganese fluoride, manganese hydroxide, cobalt nitrate, cobalt nitrite, cobalt sulfite, cobalt sulfate, cobalt carbonate, cobalt chloride, cobalt bromide, cobalt iodide, cobalt fluoride, cobalt hydroxide, nickel nitrate, nickel nitrite, nickel sulfite, nickel sulfate, nickel carbonate, nickel chloride, nickel bromide, nickel iodide, nickel fluoride and nickel hydroxide.

According to an embodiment of the present invention, stabilizers are selected from fertilizers of natural or synthetic origin that may be applied to soils or plants which supply or modulate the uptake of one or more plant nutrients (including water) essential to the growth of plants.

According to an embodiment of the present invention, said fertilizers provide nutrients necessary for plant growth including: the primary macronutrients nitrogen (N), phosphorus (P), potassium (K); secondary macronutrients calcium (Ca), sulfur (S), magnesium (Mg); and the micronutrients or trace minerals boron (B), chlorine (Cl), manganese (Mn), iron (Fe), zinc (Zn), copper (Cu), molybdenum (Mo), and selenium (Se).

According to an embodiment of the present invention, the agrochemical ingredients have free ion(s) or the ion(s) are available to form a complex with a conazole fungicide and may act as stabilizer.

According to an embodiment of the present invention, mancozeb having free Mn⁺² and Zn⁺² ions available to complex with conazole fungicide acts as stabilizer.

In another embodiment, the stabilizer is present in an amount to prevent chemical degradation of the conazole fungicide in the improved composition. According to other embodiments, the stabilizer is present in an amount from about 0.01% to about 10% by weight of a composition.

According to another embodiment, the stabilizer is at least 0.01% by weight of the improved composition.

According to an embodiment of the present invention, the improved composition comprises a de-complexing agent.

According to an embodiment of the present invention, the de-complexing agents are selected from the group comprising polymeric surfactants, chelating agents, inorganic and organic salts, amino acids and peptides wherein, said amino acids and peptides do not contain sulphur.

According to an embodiment of the present invention, the de-complexing agents are selected from the group comprising polymeric surfactants.

According to an embodiment of the present invention, the de-complexing agents are polymeric surfactants selected from group comprising one or more nonionic polymeric surfactants, anionic polymeric surfactants, amphoteric polymeric surfactants, cationic polymeric surfactants, and combinations thereof.

According to an embodiment of the present invention, the de-complexing agents are polymeric surfactants selected from group comprising one or more polyethylene oxide-polypropylene oxide block copolymers, polyethylene glycol ethers of linear alcohols, reaction products of fatty acids with ethylene oxide and/or propylene oxide, and also polyvinyl alcohol, polyvinylpyrrolidone, copolymers of polyvinyl alcohol and polyvinylpyrrolidone, and copolymers of (meth)acrylic acid and (meth)acrylic esters, and also alkyl ethoxylates and alkylarylethoxylates, which optionally may be phosphated and optionally may be utilized with bases, it being possible for mention to be made, by way of example, of sorbitol ethoxylates, and also polyoxyalkylenamine derivatives.

According to an embodiment of the present invention, the de-complexing agent is a chelating agent. According to an embodiment of the present invention, the chelating agents are selected from the group comprising amino polycarboxylic acid chelating agents, aromatic and aliphatic carboxylic acid chelating agents, amino acid chelating agents, crown ether chelating agents, ether polycarboxylic acid chelating agents, phosphoric acid chelating agents, hydroxycarboxylic acid chelating agents or dimethylglyoxime. The chelating agents may be in the form of the acid or salt. Examples of aminopolycarboxylic chelating acids include N,N′-ethylene bis(hydroxyphenyl)glycines (EDDHA), ethylenediamine bis(2-hydroxy-methylphenylacetic acid) (EDDHMA), N,N′-ethylene bis(2-hydroxy-5-sulfophenyl)glycine (EDDHSA), ethylenediaminetetraacetic acid (EDTA), N-(2-hydroxyethyl)-ethylenedi aminetetraacetic acid (HEDTA), cyclohexanediaminetetraacetic acid (CDTA), nitrilotriacetic acid (NTA), iminodiacetic acid (IDA), N-(2-hydroxyethyl)iminodiacetic acid (HIMDA), diethylenetriaminepentaacetic acid (DTP A), and glycoletherdiaminetetracetic acid (GEDTA) ethylenediaminedisuccinic acid (EDDS) and salts thereof.

According to an embodiment of the present invention, the de-complexing agents are inorganic and organic salts.

According to an embodiment of the present invention, the de-complexing agents are inorganic salts selected from the group comprising magnesium carbonate minerals, sodium carbonate, sodium hydrogen carbonate, ammonium sulfate, sodium sulfate, magnesium sulfate, ammonium phosphate dibasic, inorganic salts such as ammonium dihydrogen phosphate and potassium chloride, ligno sulfonate salt such as, for example, calcium lignosulfonate, sodium lignosulfonate, potassium ligno sulfonate, ammonium lignosulfonate, magnesium lignosulfonate, etc.

According to an embodiment of the present invention, the de-complexing agents are amino acids wherein said amino acids do not contain a sulphur moiety.

According to an embodiment of the present invention, the de-complexing agents are amino acids selected from the group comprising aliphatic amino acids such as alanine, glycine, isoleucine, leucine, proline, valine; aromatic amino acids such as phenylalanine, tryptophan, tyrosine; acidic amino acid such as aspartic acid, glutamic acid; basic amino acids such as arginine, histidine, lysine; hydroxylic amino acids such as serine, threonine; and amidic amino acids such as asparagine, glutamine. According to an embodiment of the present invention, the de-complexing agents are peptides wherein said peptides do not contain a sulphur moiety and preferably dipeptides selected from the group comprising dipeptides of aliphatic amino acids alanine, glycine, isoleucine, leucine, proline, valine; aromatic amino acids such as phenylalanine, tryptophan, tyrosine; acidic amino acid such as aspartic acid, glutamic acid; basic amino acids such as arginine, histidine, lysine; hydroxylic amino acids such as serine, threonine; and amidic amino acids such as asparagine, glutamine and combinations thereof. E.g. include but not limited to L-alanyl-L-alanine, glycyl-glycine, L-isoleucyl-L-isoleucine, leucyl-leucine, pronyl-proline, and valyl-valine.

In an embodiment of the present invention, the improved composition comprises from about 0.1% to about 50% w/w and preferably from about 1% to about 40% w/w de-complexing agent of the total weight of the high performing composition.

In a preferred embodiment of the present invention, the improved composition comprises from about 1% to about 30% w/w de-complexing agent of the total weight of the high performing composition.

According another aspect the present invention provides a composition comprising at least one complexed conazole fungicide, one or more agrochemical ingredient; and at least one de-complexing agent.

Accordingly, in an embodiment of the present invention, the improved composition comprises of one or more other agrochemical ingredient(s).

In some embodiments, one or more agrochemical ingredients is selected from but not limited to herbicides, insecticides, insect growth regulators, nematicides, termiticides, molluscicides, bactericides, insect repellents, animal repellents, antimicrobials, fungicides, disinfectants and sanitizers.

In some preferred embodiments, the agrochemical ingredient is selected from fungicides, antimicrobials and insecticides.

In some preferred embodiments, the agrochemical ingredient is selected from fungicides. In some most preferred embodiments, the fungicide is selected from, but not limited to, dithiocarbamate fungicides, demethylation inhibitors, quinone outside inhibitors, succiniate dehydrogenase inhibitors and quinone inside inhibitors.

In an embodiment, the dithiocarbamate fungicides contain a dithiocarbamate molecular moiety and are selected from amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

In a preferred embodiment, the dithiocarbamate fungicide is mancozeb.

In another embodiment, the quinone outside inhibitor is selected from strobilurin fungicides.

In another embodiment, the strobilurin fungicide is selected from, but not limited, to azoxystrobin, kresoxim-methyl, picoxystrobin, pyraclostrobin, and trifloxystrobin.

In an embodiment, the demethylation fungicide is selected from triazole fungicides.

In another embodiment, the triazole fungicides are selected from but are not limited to cyproconazole, flusilazole, flutriafol, metconazole, myclobutanil, propiconazole, tebuconazole, and tetraconazole.

In an embodiment, the succiniate dehydrogenase inhibitor is selected from benzovindiflupyr, bixafen, fluxapyroxad, furametpyr, isopyrazam, penflufen, penthiopyrad, sedaxane, boscalid, thifluzamide, carboxin, oxycarboxin, fenfuram, fluopyram, isofetamid, benodanil, flutolanil and mepronil.

In another embodiment the fungicide can be selected from group comprising metrafenone, amisulbrom, isotianil, fluopicolide, fenpyrazamine, valifenalate, mandipropamid, penflufen, bixafen, fluopyram, fluxapyroxad, isopyrazam, penthiopyrad, pyriofenone, sedaxane, pydiflumetofen, dichlobentiazox, isoflucypram, fenpicoxamid, florylpicoxamid, fluoxapiprolin, mefentrifluconazole, ipfentrifluconazole, methyltetraprole, inpyrfluxam, quinofumelin, oxathiapiprolin, fluindapyr, dipymetitrone, pyridachlometyl, benzovindiflupyr, orysastrobin, ametoctradin, flutianil, pyraziflumid, coumoxystrobin, pyribencarb, tebufloquin, isofetamid, tolprocarb, mandestrobin and picarbutrazox.

In an embodiment of the present invention, the improved composition comprising from about 1% to about 95% w/w and preferably from about 5% to about 90% w/w dithiocarbamate fungicide of the total weight of the improved composition.

In a preferred embodiment of the present invention, the improved composition comprises from about 10% to about 80% w/w dithiocarbamate fungicide of the total weight of the improved composition.

According to an embodiment of the present invention, the improved composition may optionally include other agrochemically acceptable excipients. Examples are surfactants, dispersing agents, wetting agents, emulsifiers, suspension agents, defoamers, penetrants, antioxidants, stabilizers, pH adjustors, fertilizers, rheology modifiers or thickeners, inert ingredients and combinations thereof.

According to an embodiment of the present invention, the improved composition surfactants that can be used as wetting agents and/or dispersing agents include sulfosuccinates, naphthalene sulfonates, sulphated esters, phosphate esters, sulfated alcohol, aikyl benzene sulfonates polycarboxylates, naphthalene sulfonate condensates, phenol sulfonic acid condensates, lignosulfonates, methyl oleyltaurates and polyvinyl alcohols. Further it is possible to use other surfactants known in the art without departing from the scope of the invention.

According to an embodiment of the present invention, the improved composition can comprise pH modifiers. Suitable pH modifiers comprise buffers. Examples are alkali metal salts of weak inorganic or organic acids.

According to an embodiment of the present invention, the improved composition comprises a rheology modifier (or a thickener). Suitable compounds are all those compounds usually employed for this purpose in agrochemical compositions. Examples include bentonites, attapulgites, polysaccharides, xanthan gum and kelzan gum. In another embodiment of the present invention, the compositions comprise antifreeze agents. Suitable antifreeze agents are liquid polyols, for example ethylene glycol, propylene glycol or glycerol.

In another embodiment of the present invention, the improved compositions comprise defoamers selected from non-silicone or silicone based antifoaming agents.

Accordingly, in certain embodiments, there is provided a composition comprising a conazole fungicide, a stabilizer, a de-complexing agent and a dithiocarbamate fungicide.

In certain embodiments, there is provided a composition comprising prothioconazole, a stabilizer, a de-complexing agent and mancozeb.

In certain preferred embodiments, the composition comprises prothioconazole, mancozeb and a de-complexing agent.

Accordingly, in certain embodiments, the composition comprises prothioconazole, a stabilizer, a de-complexing agent and kresoxim-methyl.

Accordingly, in certain embodiments, the composition comprises prothioconazole, a stabilizer, a de-complexing agent and picoxystrobin.

Accordingly, in certain embodiments, the composition comprises hexaconazole, a stabilizer, a de-complexing agent and azoxystrobin.

Accordingly, in certain embodiments, the composition comprises tebuconazole, a stabilizer, a de-complexing agent and pyraclostrobin.

In an embodiment, the composition comprises from about 0.01% to about 40% w/w conazole fungicide, from about 0.01% to about 10% w/w stabilizer, from about 1% to about 95% w/w another agrochemical ingredients, and from about 0.1% to about 50% w/w de-complexing agent.

In an embodiment, the composition comprises from about 1% to about 30% w/w prothioconazole, from about 0.1% to about 10% w/w copper hydroxide, from about 1% to about 90% w/w mancozeb, and from about 1% to about 20% w/w polyalkylene oxide block copolymer.

In an embodiment, the composition comprises from about 1% to about 30% w/w prothioconazole, from about 0.1% to about 10% w/w copper salt, from about 1% to about 90% w/w zineb, and from about 1% to about 20% glycylglycine peptide.

In an embodiment of the present invention, the composition is formulated as a solid composition including, but not limited to, dust, powder, granules, pellets, tablets, dry flowable, wettable powder or water dispersible granules.

In an embodiment of the present invention, the composition is preferably formulated as water dispersible granules.

In an embodiment of the present invention, the composition is formulated as a liquid composition including, but not limited to, a suspension concentrate, an aqueous dispersion, a solution, a suspoemulsion, a micro-dispersion, and/or a dilutable dispersion.

In an embodiment of the present invention, the composition is preferably formulated as a suspension concentrate.

In an embodiment, the composition comprises from about 0.1% to about 50% w/w prothioconazole, from about 1% to about 90% w/w mancozeb, and from about 0.1% to about 10% w/w esters of alkoxylated diethylethanolamine (such as Atlox™ 4915), wherein said improved composition is in the form of Water Dispersible Granules (WDG).

In an embodiment, the improved composition comprises from about 0.1% to about 50% w/w prothioconazole, from about 1% to about 90% w/w mancozeb, from about 0.1% to about 10% w/w copper hydroxide, and from about 01.% to about 20% w/w ethylenediamineaaceticacid (EDTA), wherein said high performing composition is in the form of Suspension Concentrate (SC).

According to an embodiment of the present invention, the improved composition comprising at least one complexed conazole fungicide; a stabilizer, another agrochemical ingredient, and at least one de-complexing agent may be formulated as a premix in the form of the above described solid and liquid compositions.

According to an embodiment of the present invention, the improved composition comprising at least one complexed conazole fungicide; a stabilizer, another agrochemical ingredient, and at least one de-complexing agent may be formulated as a tank mix composition by separately adding the complexed conazole, the stabilizer, the another agrochemical ingredient and de-complexing agent in a tank and adding water to make up the volume.

In an embodiment, the improved composition of the invention has a pH ranging from 4-7.

In an embodiment, the improved composition of the invention possesses a characteristic particle size distribution.

In an embodiment, the improved composition of the invention has a particle size distribution D50 of less than about 5.0 microns.

In an embodiment, the improved composition of the invention has a particle size distribution D50 of less than about 3.5 microns.

In an embodiment, the improved composition of the invention has a particle size distribution D50 of less than or equal to about 3.0 microns.

In an embodiment, the improved composition of the invention has a particle size distribution D50 of less than or equal to about 2.5 microns.

In an embodiment, the improved composition of the invention has a particle size distribution D90 of less than or equal to about 30 microns.

In an embodiment, the improved composition of the invention has a particle size distribution D90 of less than or equal to about 20 microns.

In an embodiment, the improved composition of the invention has a particle size distribution D90 of less than or equal to about 10 microns. In an embodiment, the improved composition of the invention has a particle size distribution Dioo of less than or equal to about 125 microns.

In an embodiment, the improved composition of the invention has a particle size distribution Dioo of less than or equal to about 60 microns.

In an embodiment, the improved composition of the invention has a particle size distribution Dioo of less than or equal to about 25 microns.

In an embodiment, the improved composition of the invention has a particle size distribution Dio of less than about 1.5 microns, and D50 of less than about 5.0 microns.

In an embodiment, the improved composition of the invention has a particle size distribution Dio of less than about 1.0 microns, and D50 of less than about 3.5 microns.

In an embodiment, the improved composition of the invention has a particle size distribution D50 of less than or equal to about 3.0 microns, and D90 of less than or equal to about 30 microns.

According to an embodiment of the present invention, there is provided a process for producing a composition, comprising a complexed conazole fungicide and a de-complexing agent.

According to an embodiment, the process for producing a composition, comprises mixing at least one complexed conazole fungicide and at least one de-complexing agent to obtain the composition.

According to another embodiment, the process for producing a composition comprising (a) at least one complexed conazole fungicide; and (b) at least one de-complexing agent selected from polymeric surfactants, chelating agents, inorganic and organic salts, amino acids and peptides wherein said amino acids and peptides do not contain sulphur, comprises: a) mixing at least one complexed conazole fungicide with a de-complexing agent to obtain a pre-mix, b) processing the pre-mix in a desired form.

According to an embodiment of the present invention, processing the pre-mix in a desired form is to obtain solid and liquid agrochemical formulations selected from dust, powder, pellets, tablets, dry flowable, wettable powder, water dispersible granules, suspension concentrate, aqueous dispersion, dispersible concentrate, solution, suspoemulsion, micro dispersion, and/or dilutable dispersion.

According to an embodiment, the process for producing a composition comprising (a) at least one complexed conazole fungicide, (b) at least one de-complexing agent, and (c) at least one agrochemical ingredient comprises: a) mixing at least one complexed conazole fungicide and optionally other auxiliary ingredients to obtain a mixture, b) adding a de-complexing agent in said mixture to obtain a pre-mix, c) adding at least one agrochemical ingredient to said premix of step (b) to obtain a heterogeneous mix, and d) processing the heterogeneous mix in a desired form.

In certain embodiments, the improved composition comprising (a) a complexed conazole fungicide, (b) a de-complexing agent, and (c) at least one agrochemical ingredient is prepared in the form of water dispersible granules wherein, said process comprises the steps of: a) mixing a complexed conazole fungicide and other auxiliary ingredients to obtain a mixture, b) adding a de-complexing agent to said mixture to obtain a pre-mix, c) optionally, adding at least one agrochemical ingredient to the premix of step (b), d) obtaining granules from said pre-mix, and e) packing said granules and storing said packaged granules.

In certain embodiments, the improved composition comprising (a) a complexed conazole fungicide, (b) a de-complexing agent, and (c) at least one agrochemical ingredient is processed in the form of water dispersible granules wherein, said process comprises the steps of: a) mixing a complexed conazole fungicide and other auxiliary ingredients in a suitable solvent to obtain a mixture, b) milling the mixture with water to obtain a premix slurry, c) adding at least one agrochemical ingredient to the premix slurry of step (b) to obtain a blend, d) spray drying the blend of step (c) to obtain granules, e) optionally, further drying the granules of step (d) in fluidized bed dryer; and f) packing the dried granules and storing the packaged granules.

In certain embodiments, the improved composition comprising (a) a complexed conazole fungicide, (b) a de-complexing agent, and (c) at least one agrochemical ingredient, is processed in the form of a suspension concentrate wherein, said process comprises the steps of:
(a) preparing first suspension concentrate premix of the complexed conazole fungicide,
(b) preparing a second suspension concentrate premix of at least one agrochemical ingredient,
(c) mixing a stabilizer with the premix of step (a) under continuous stirring to obtain a blend,
(d) adding the premix of step (b) to the blend of step (c) to obtain a heterogeneous mixture,
(e) adding the de-complexing agent to the heterogeneous mixture of step (d) to obtain the suspension concentrate.

In some embodiments, the above steps of preparing the improved composition can be performed in any order without deviating from the spirit of the present invention.

According to an embodiment of the present invention, said suitable solvent is water.

In some embodiments, the process includes solvents commonly used in agricultural compositions.

In certain other embodiments, suitable solvents that may be used in this process include, but are not limited to, alcohols, ketones, aliphatic or aromatic hydrocarbons, chlorinated hydrocarbons, amide solvents vegetable oils, their derivatives or mixtures thereof.

Further, the present invention provides a method of controlling unwanted pests, said method comprising applying an effective amount of a composition comprising (a) at least one complexed conazole fungicide; and (b) at least one de-complexing agent selected from polymeric surfactants, chelating agents, inorganic and organic salts, amino acids and peptides, wherein said amino acids and peptides do not contain sulphur, to the pests or to their habitat.

According to an embodiment of the present invention, a method of controlling unwanted pests comprises applying an effective amount of a composition comprising (a) at least one complexed conazole fungicide, (b) at least one de-complexing agent selected from polymeric surfactants, chelating agents, inorganic salts and organic salts, amino acids and peptides, wherein said amino acids and peptides do not contain sulphur, and (c) at least one agrochemical, to the pests or to their habitat.

According to another embodiment of the present invention, a method of controlling unwanted pests comprises applying an effective amount of a composition comprising (a) a complexed prothioconazole fungicide and (b) at least one de-complexing agent, to the pests or to their habitat.

According to another embodiment of the present invention, a method of controlling unwanted pests comprises applying an effective amount of a composition comprising (a) a complexed prothioconazole fungicide and (b) at least one de-complexing agent, and (c) mancozeb, to the pests or to their habitat.

According to an embodiment of the present invention, there is provided a kit of a composition comprising:
(a) at least one complexed conazole fungicide;
(b) at least one de-complexing agent; wherein the de-complexing agent is selected from polymeric surfactants, chelating agents, inorganic and organic salts, amino acids and peptides wherein said amino acids and peptides do not contain sulphur.

According to an embodiment of the present invention, various components of the improved composition can be used individually or already partially or completely mixed with one another to prepare the composition according to the invention. It is also possible for them to be packaged and used further as combination composition such as a kit of parts. In one embodiment of the invention, the kits may include one or more, including all, components that may be used to prepare improved composition. For example, the kit may include active ingredients and/or de-complexing agent. One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of the kit may be packaged separately, i.e., not pre-formulated. As such, kits may include one or more separate containers such as vials, cans, bottles, pouches, bags or canisters, each container containing a separate component for a composition.

In both forms, a component of the kit may be applied separately from or together with the further components or as a component of a combination composition according to the invention for preparing the improved composition according to the invention.

In a preferred embodiment of the present invention, the improved composition comprising (a) at least one complexed conazole fungicide, (b) at least one de-complexing agent, and (c) optionally, other auxiliary ingredients, are in the form of a kit with a single pack or a multi pack.

According to an embodiment of the present invention, the improved composition comprising at least one complexed conazole fungicide; and at least one de-complexing agent is used as pesticide.

According to some embodiments of the present invention, the improved composition comprising at least one complexed conazole fungicide; and at least one de-complexing agent selected from polymeric surfactants, chelating agents, inorganic and organic salts, amino acids and peptides, wherein said amino acids and peptides do not contain sulphur, is used as fungicide.

According to some embodiments, the improved composition according to the present invention can be used for pest control on plants, plant parts, seeds, seedlings, or on soil.

The improved composition as described above is fungicidally efficacious and stable. It has been found that the de-complexing agent of the present invention is able to successfully break a conazole fungicide existing in complex form with the stabilizer or another agrochemical ingredient capable of donating a free ion to form a complex with the conazole fungicide in order to provide stability to the conazole fungicide. The de-complexing agent of the high performing composition enhances the availability of free conazole fungicide to impart biological action. This enhanced availability of free conazole fungicide is seen as remarkably bioefficacy results obtained while said improved composition is applied on pests or onto their lotus. Also, the improved composition obtained by the process have superior suspensibility, better dispersibility, very low or no sedimentation and little particle degradation.

All the features described herein may be combined with any of the above aspects, in any combination.

In order that the present invention may be more readily understood, reference will now be made, by way of example, to the following description. It will be understood that all tests and physical properties listed have been determined at atmospheric pressure and room temperature (i.e., 25° C.), unless otherwise stated herein, or unless otherwise stated in the referenced test methods and procedures.

### Example 1: A Composition of Mancozeb 560 G/Kg and Prothioconazole 80 G/Kg WG According to the Present Invention as Given Below

| | Content |
|---|---|
| Ingredient | (g/kg) |
| Prothioconazole | 83 |
| Mancozeb | 651 |
| Sodium lignosulfonate | 171 |
| Glycylglycine | 80 |
| Silicone antifoam | 15 |
| Total | 1000 |

83 gm of prothioconazole was blended with a partial amount of sodium lignosulphonate and silicone antifoam in water to form a premix slurry. Said premix slurry is homogenized by stirring and dispersed using a colloid mill. Said premix slurry was further milled using a bead mill until the particle size was reduced to D50 below 5 micron and D90 below 10 micron. 651 gm of mancozeb was blended with premix slurry of prothioconazole along with the remaining sodium lignosulphonate, glycylglycine and silicone antifoam in water to obtain a blend. Said blend was then homogenized by stirring and dispersed using a colloid mill and further sprayed into the spray dryer through nozzles. In the spray-dryer, a hot inert air stream (temperatures ranging between 175° C. and 300° C.) evaporated the water out of the droplets to form spherical granules. The outlet temperature of the spray dryer (and thereby the temperature of the granules) varied between 90-115° C. Subsequently, the granules were further dried in a fluid bed dryer operating at 90-120° C. to remove the remaining moisture.

### Example 2: A Composition of Mancozeb 560 G/Kg and Prothioconazole 80 G/Kg WG According to the Present Invention as Given Below

| | Content |
|---|---|
| Ingredient | (g/kg) |
| Prothioconazole | 82 |
| Mancozeb | 651 |
| Sodium lignosulfonate | 171 |
| Ethylenediaminetetraacetic acid | 81 |
| Silicone antifoam | 15 |
| Total | 1000 |

The above measured quantities of prothioconazole, mancozeb, sodium alkyl sulfate, sodium lignosulphonate, ethylenediaminetetraacetic acid and silicone antifoam were mixed in a given ratio shown above and granules were prepared as per the process of Example 1.

### Example 3: A Composition of Mancozeb 560 G/Kg and Prothioconazole 80 G/Kg WG According to the Present Invention as Given Below

| | Content |
|---|---|
| Ingredient | (g/kg) |
| Prothioconazole | 82 |
| Mancozeb | 651 |
| Sodium lignosulfonate | 199.5 |
| Poly(ethylene glycol)-bock-poly | 50 |
| (propylene glycol)-block-poly | |
| (ethylene glycol) | |
| Kaolin | 79.5 |
| Silicone antifoam | 15 |
| Total | 1000 |

The prothioconazole, mancozeb, sodium lignosulphonate, ethylene oxide/propylene oxide block copolymer and silicone antifoam are mixed in a given ratio shown above and granules were prepared as per the process of Example 1.

### Example 4: A Composition of Mancozeb 560 G/Kg and Prothioconazole 80 G/Kg WG According to the Present Invention as Given Below

| | Content |
|---|---|
| Ingredient | (g/kg) |
| Prothioconazole | 83 |
| Mancozeb | 651 |
| Sodium lignosulfonate | 171 |
| Ammonium sulphate | 93 |
| Silicone antifoam | 2 |
| Total | 1000 |

The prothioconazole, mancozeb, sodium isopropyl naphthalene sulfonate, sodium lignosulfonate, ammonium sulphate and silicone antifoam are mixed in a given ratio shown above and granules were prepared as per the process of Example 1.

### Example 5: A Composition of Mancozeb+Prothioconazole 560+80 G/Kg WG with Dipeptide (Dry Process) According to the Present Invention as Given Below

| | Content |
|---|---|
| Ingredient | (g/kg) |
| Prothioconazole | 83 |
| Mancozeb | 651 |
| Sodium lignosulfonate | 171 |
| Glycylglycine | 80 |
| Silicone antifoam | 15 |
| Total | 1000 |

Prothioconazole, sodium isopropyl naphthalene sulfonate, sodium lignosulfonate, glycylglycine and kaolin were added in above mentioned quantity and blended in a ribbon blender for 20-30 min to obtain blend. This blend was further grounded in air jet mill to obtain grounded mix having particle size Dioo below 15 micron. Mancozeb was added to the ground blend and then mixed for 40-50 min to obtain homogeneous mixture. The homogeneous mixture was taken to prepare a dough using water containing the requisite amount silicone antifoam. Granules were then extruded in a granulator. The extruded granules were dried on fluid bed dryer at temperature ranging between 90° C. to 120° C. The dried granules were passed through sieve to obtain uniformly sized granules. Undersized and oversized granules were recycled back. Finished granules were packed in a suitable packaging.

### Example 6: A Composition of Mancozeb 560 G/Kg+Prothioconazole 80 G/Kg (Comparative Example without De-Complexing Agent)

| | Content |
|---|---|
| Ingredient | (g/kg) |
| Prothioconazole (Purity 98%) | 83 |
| Mancozeb (Purity 87%) | 651 |
| Sodium isopropyl naphthalenesulfonate | 21 |
| Sodium lignosulfonate | 150 |
| Kaolin clay | 80 |
| Silicone antifoam | 15 |
| Total | 1000 |

The prothioconazole, mancozeb, sodium isopropyl naphthalene sulphonate, sodium lignosulfonate, kaolin clay and silicone antifoam are mixed in a given ratio shown above and granules were prepared as per the process of Example 1. This composition is prepared without de-complexing agent for the purpose of comparison.

### Example 7: Prothioconazole 47.9 G/Kg+Mancozeb 333 G/Kg Sc (a Kit Based Formulation)

| | Quantity |
|---|---|
| Ingredients | (g) |
| Part A | |
| Prothioconazole 391 g/Kg SC premix | |
| Prothioconazole (purity 98.7%) | 399.7 |
| Monopropylene glycol | 68.8 |
| Sodium lignosulfonate | 38.7 |
| Silicone antifoam | 93.7 |
| Xantham gum | 3.0 |
| Proxel GXL | 1.5 |
| Water | 395.6 |

Mancozeb 428g/Kg SC premix

| | |
|---|---|
| Mancozeb (purity 86%) | 497.3 |
| Monopropylene glycol | 35.6 |
| Sodium lignosulfonate | 32.1 |
| Defoamer | 7.2 |
| Water | 427.8 |

Mancozeb 333 + Prothioconazole 47.9 g/Kg SC

| | |
|---|---|
| Mancozeb SC | 778.8 |
| Prothioconazole SC | 122.6 |
| Copper hydroxide | 7.3 |
| Potassium carbonate | 3.4 |
| Xantham gum | 1.2 |
| Proxel GXL | 0.6 |
| Water | 86.1 |

Part B

| | |
|---|---|
| Glycylglycine | 80 |

Part A: Prothioconazole was mixed with monopropylene glycol, sodium lignosulfonate, defoamer and a part of the water. The mixture was bead milled until a particle size of d50 below 3 μm and d90 below 10 μm was achieved. To the premix is added, the thickener gel consisting of xanthan gum and Proxel™ GXL in water. Stirring was continued until the mixture became homogenous. Separately, mancozeb was mixed with monopropylene glycol, antifoam, water and sodium lignosulfonate. Stirring was continued until the mixture became homogenous. To the prothioconazole SC premix was added copper hydroxide. The mixture was stirred, followed by the addition of mancozeb SC premix. Potasssium carbonate was added to adjust the pH to 6-7. To this mixture was added the thickener gel consisting of xanthan gum and Proxer™ GXL in water. Water is added to make-up the quantity.

Part B: 80 g Glycylglycine was prepared in the form of a dry powder as homogeneous mixture with uniform particle size and packed separately in an air tight packing.

Therefore, Part A and Part B were prepared to be mixed together at the time of tank-mix application.

### Example 8: Effect of De-Complexing Agents on the Application Recovery of Prothioconazole

Compositions were prepared using various de-complexing agents and their effect were studied on the application recovery of prothioconazole. The purpose of studying the application recovery is to quantify the percentage availability of free prothioconazole in the formulation which is meant to be applied on pests or onto their locus for its action. The free prothioconazole content in the formulation marked the effectiveness of de-complexing agent in breaking the complexed conazole present in the formulation. The more the application recovery, more effective the de-complexing agent could be considered.

### Quantitative Sample Preparation

0.6 g sample was taken in a 30 mL vial. 1 mL water was added to disperse the sample followed by addition of 10 mL acetonitrile containing phtalate as an internal standard. THE mixture was kept for sonication for 5-10 min. The sample was kept for some time to bring it down to RTP (Room Temp. & Pressure). An aliquot of this sample was then filtered using a nylon syringe filter and diluted 5 times with acetonitrile. 10 μL of this sample was injected into the HPLC and the content of prothioconazole was determined.

### Application Recovery Protocol:

Prepare a tank mix solution of the sample at the highest dose rate in hard water D (or in a solution of de-complexing agent (0.1% or 0.5%) in hard water D) of the sample at the highest dose rate in a 250 mL measuring cylinder. After 30 inversions, immediately pipette 5 mL of the solution and add 15 mL of internal standard dissolved in acetonitrile. Ultrasonicate for 5 minutes. Filter an aliquot and dilute 5 times with acetonitrile. Inject 10 pL into the HPLC and determine the content of prothioconazole.

The inventors of the present invention found that the application recovery of prothioconazole in the compositions comprising a de-complexing agent is above 80%. The compositions prepared without adjuvant shown just 32% application recovery of prothioconazole. This confirms that the de-complexing agent proved to be very effective in breaking the complexed conazole structure releasing free prothioconazole in the formulation for its performance when applied on pests or onto their locus. Results are presented below in Table 1.

TABLE 1

| Entry | A | B | C | D | E |
|---|---|---|---|---|---|
| De-complexing agents | Without | Dipeptide | EDTA | Polymeric | Ammonium |
| | De- | | | surfactant | sulphate |
| | complexing | | | | |
| | agent | | | | |
| Example | Exm-6 | Exm-1 | Exm-2 | Exm-3 | Exm-4 |
| Specification | | | | | |
| Content Mancozeb (g/Kg) | 568 | 570 | 563 | 546 | 572 |
| Content Prothioconazole (g/Kg) | 80 | 80 | 80 | 80.5 | 81 |
| pH (1%) | | | | | |
| Suspensibility*Mancozeb | 73 | 72% | 72% | 78 | 80% |
| Suspensibility*Prothioconazole | 79 | 60% | 70% | 85% | 94% |
| Application recovery of | 32% | 84% | 98% | 81% | 84% |
| Prothioconazole | | | | | |

Effect of De-Complexing agents on the Application Recovery of Prothioconazole when de-complexing agents are added in tank-mix. Similarly, a few more compositions were prepared by adding peptides and amino acids which do not contain sulphur (de-complexing agents as per the present invention) in tank-mix various and their effect were studied on the application recovery of prothioconazole. The purpose of studying application recovery is to quantify the percentage availability of free prothioconazole in the formulation which is meant to be applied on pests or onto their locus for its action. It was observed that peptides and amino acids which do not contain sulphur (de-complexing agents as per the present invention) were added in tank-mix preparations, the availability of prothioconazole increased substantially. Composition prepared according to Example-6 was taken and each time amino acids and peptide and their concentration were changed keeping other ingredients same as per Example-6. Tank mix of comparative Example 6 with different de-complexing agents was represented in Table 2.

TABLE 2

| | | Application |
|---|---|---|
| De-complexing | Concentration | recovery |
| agents | in Tank mix | Prothioconazole |
| None | | 32% |
| Glycylglycine | 0.1% | 72% |
| Glycylglycine | 0.5% | 94% |
| Alanylalanine | 0.1% | 58% |
| Alanylalanine | 0.5% | 82% |
| Glycine | 0.1% | 82% |
| Glycine | 0.5% | 98% |
| Lysine | 0.1% | 65% |
| Lysine | 0.5% | 92% |
| Glutamic acid | 0.1% | 75% |
| Glutamic acid | 0.5% | 98% |
| Phenylanaline | 0.1% | 74% |
| Phenylanaline | 0.5% | 97% |

Further, the effect of various de-complexing agents on the application recovery of a liquid composition (as per Example 7) was studied. Various de-complexing agents were added to the liquid composition of prothioconazole+mancozeb SC of example 7 in a tank mix and application recovery was calculated. (Table 3). It was found that even in a tank-mix formulation, de-complexing agents worked well to enhance the availability of prothioconazole. Tank mix of liquid composition Example 7 with different de-complexing agents was represented in Table 3.

TABLE 3

| | | Application |
|---|---|---|
| De-complexing | Concentration | recovery |
| agents | in Tank mix | Prothioconazole |
| None | | 27% |
| Glycylglycine | 0.1% | 40% |
| Glycylglycine | 0.5% | 93% |
| EDTA | 0.1% | 62% |
| EDTA | 0.5% | 100% |
| Polyalkylene oxide | 5% | 68% |
| blockpolymer | | |
| Polymeric amphoteric | 5% | 85% |
| dispersant | | |

### Test for Suspensibility and Stability of the Active Ingredient

The high performing composition prepared according to the present invention (Example-3) was investigated for suspensibility of active ingredients, particle size, pH, wet sieve and its effect on stability of the composition.

As shown in Table 4, no significant change was observed in the suspensibility of prothioconazole and mancozeb in the composition when studied at ambient conditions as well as in AHS (after 2 weeks at 54° C.). The composition was further tested by wet sieve analysis. The degree to which particles may be aggregated is often measured by a wet sieve retention test as described in CIPAC test MT 59.3. In this test, the dispersed solid is poured through a series of fine sieves and the retained material is measured as a fraction of the total amount of dispersed material. The compositions prepared according to the present invention were found to have low wet sieve retention ranging from 0.2% to 0.6% which is within the acceptable zone. The pH of the high performing compositions was found to be ranging from 5-6. In an embodiment, the high performing composition of the invention has a particle size distribution D50 of less than or equal to about 10 microns. The composition according to the present invention remained stable according to the physico-chemical parameters being tested (Table 4).

TABLE 4

| | Exm-3 | |
|---|---|---|
| | Dipeptide | |
| De-complexing agents | | After 2 wks |
| Ingredients | Initial | at 54° C. |
| Content Mancozeb (g/kg) | 570 | 569 |
| Content Prothioconazole | 80 | 80 |
| (g/kg) | | |
| Water Content | 1.30% | |
| SuspensibilityMancozeb | 72% | 68% |
| SuspensibilityProthioconazole | 60% | 67% |
| Application recovery | 84% | |
| Prothioconazole | | |
| Wet sieve residue (45 μm) | 0.44% | 0.40% |
| Particle size (D₅₀) | 4.3 μm | 4.8 μm |
| Particle size (D9₀) | 12.4 μm | 15.2 μm |

### Biological Efficacy Testing of High Performing Composition:

The high performing composition prepared according to the present invention was tested in the greenhouse to evaluate its biological efficacy. For the study purpose, efficacy was tested for the composition of example-3 and composition of example-6 against Septoria leaf blotch (Zymo Septoriatriticii). For comparative purpose prothioconazole 250 g/L EC market sample and a tank mix of prothioconazole 250 g/L EC with mancozeb 500 g/L SC market sample without decomplexing agent were also taken in the plots.

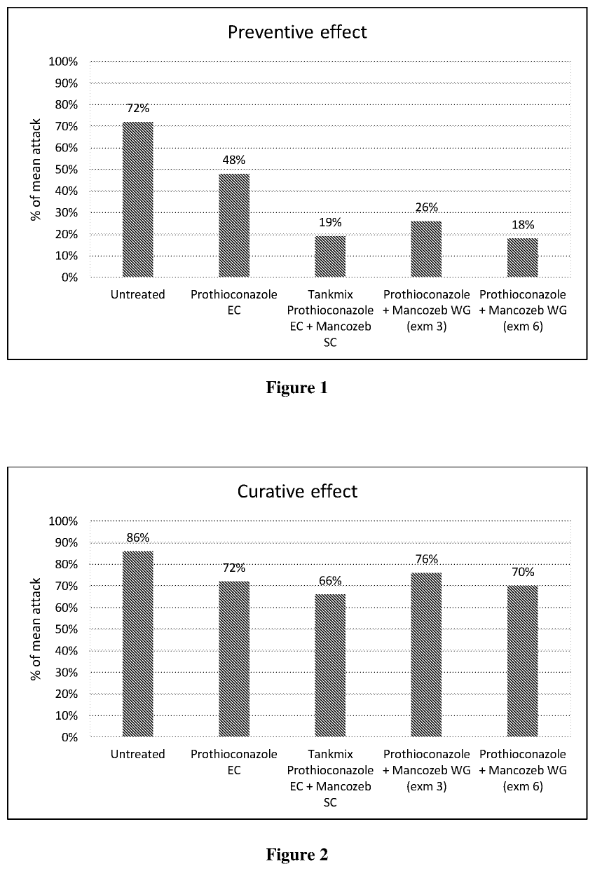

Treatment was done by spraying the fungicides on basis of a spray dose of 45 g/Ha prothioconazole and 350 g/Ha mancozeb (0.625 kg/Ha mancozeb+prothioconazole 560+80 g/kg WG) on wheat plants at 3 leaf stage. The efficacy was tested in a preventative way i.e., spraying was done 1 day prior infection with the Septoriatriticii fungi. Infection was carried out by spraying a spore suspension of Zymo Septoriatriticii. After infection, the plants were incubated in a climate chamber at 21° C. for 28 days. Then the degree of fungus damage was evaluated. It was observed that good control of fungus was observed when the fungus is treated with composition of Exm-3 having a decomplexing agent prepared according to the present invention. Its efficacy was comparable with the efficacy of the tank-mix preparation wherein prothioconazole is not existing in the complexed form (Results in Graph of FIG. 1). Lesser control was observed with the composition of example-6 prepared without de complexing agent. Application recoveries of prothioconazole for the tested mixtures is shown in table 5.

TABLE 5

| | Decomplexing | | Application |
|---|---|---|---|
| | agent | Dose rate | recovery |
| Prothioconazole 250 g/L EC | None | 0.18 kg/Ha | 100% |
| Prothioconazole 250 + | None | 0.18 kg/Ha + 0.70 kg/Ha | 94% |
| Mancozeb 500 g/L | | | |
| Mancozeb + Prothioconazole | Polymeric | 0.625 kg/Ha | 81% |
| 540 + 80 g/kg WG (Exm-3) | surfactant | | |
| Mancozeb + Prothioconazole | None | 0.625 kg/ha | 32% |
| 540 + 80 g/kg WG (Exm-6) | | | |

Similarly, curative dose response was studied on wheat crop wherein treatment was applied on 7 days after infection with the fungi.

Good control of fungus was observed when the fungus is treated with composition of example 3 prepared according to the present invention wherein comparatively lower control was observed with the composition of example 6 prepared without de-complexing agent and is represented in Graph of FIG. 2. Therefore, the high performing composition comprising complexed prothioconazole was successfully prepared. De-complexing agents according to the present facilitated breaking of prothioconazole-stabilizer complex and free prothioconazole made available for its activity. The compositions according to the present invention passed stability tests and active ingredients remained quite stable in various experimental conditions. Also, the high performing composition showed remarkable results in fields during bioefficacy testing.

1. A composition comprising: a) at least one complexed conazole fungicide; and b) at least one de-complexing agent; wherein the de-complexing agent is selected from polymeric surfactants, chelating agents, inorganic and organic salts, amino acids and peptides, wherein said amino acids and peptides do not contain sulphur.

2. The composition as claimed in claim 1, wherein the complexed conazole fungicide comprises the conazole fungicide complexed with a stabilizer.

3. The composition as claimed in claim 1, wherein the conazole fungicide is prothioconazole, cyproconazole, hexaconazole, tebuconazole, azaconazole, bromuconazole, diclobutrazol, difenoconazole, diniconazole, diniconazole-M, epoxiconazole, etaconazole, fenbuconazole, fluconazole, fluquinconazole, flusilazole, flutriafol, furconazole, furconazole-cis, imibenconazole, ipconazole, ipfentrifluconazole, mefentrifluconazole, metconazole, myclobutanil, penconazole, propiconazole, quinconazole, simeconazole, tetraconazole, thiabendazole (triazole), triadimefon, triadimenol, triticonazole, uniconazole, uniconazole-P, a salt, ester, isomer, or derivatives thereof.

4. The composition as claimed in claim 2, wherein the stabilizer is a salt of a transition metals, a fertilizer, or an agrochemical ingredients having free ion(s) or ion(s) available to form a complex with the conazole fungicide.

5. The composition as claimed in claim 2, wherein the stabilizer is copper nitrate, copper sulfate, copper chloride, ferric chloride, ferric hydroxide, zinc sulfate, manganese sulfate, manganese carbonate, manganese chloride, manganese bromide, manganese iodide; a fertilizer, mancozeb, maneb, or zineb.

6. The composition as claimed in claim 2, wherein said composition comprises the stabilizer in an amount from about 0.01% w/w to about 10% w/w of the total weight of the composition.

7. The composition as claimed in claim 1, wherein the de-complexing agent is a nonionic polymeric surfactants, an anionic polymeric surfactants, an amphoteric polymeric surfactants, a cationic polymeric surfactants, an amino polycarboxylic acid chelating agents, an aromatic or aliphatic carboxylic acid chelating agents, an amino acid chelating agents, a crown ether chelating agents, an ether polycarboxylic acid chelating agents, a phosphoric acid chelating agents, a hydroxycarboxylic acid chelating agents or dimethylglyoxime, an inorganic salt, an organic salts, an aliphatic amino acids, or a dipeptide of an aliphatic amino acids.

8. The composition as claimed in claim 7, wherein said composition comprises the de-complexing agent in an amount from about 0.1% w/w to about 50% w/w of the total weight of the composition.

9. The composition of claim 1, further comprising c) one or more agrochemical ingredients.

10. The composition as claimed in claim 9, wherein said agrochemical active ingredient is a fungicide selected from dithiocarbamate fungicides, demethylation inhibitors, quinone outside inhibitors, succiniate dehydrogenase inhibitors and quinone inside inhibitors.

11. The composition as claimed in claim 9, wherein said one or more agrochemical active ingredient is selected from mancozeb, maneb, zineb, ziram, thiram, azoxystrobin, kresoxim-methyl, picoxystrobin, pyraclostrobin, trifloxystrobin, bixafen, fluxapyroxad, boscalid, and thifluzamide.

12. The composition as claimed in claim 9, wherein said composition comprises from about 0.01% to about 40% w/w of the conazole fungicide, from about 1% to about 95% w/w of the one or more agrochemical ingredients, and from about 0.1% to about 50% w/w of the de-complexing agent.

13. A process for producing the composition as claimed in claim 1, comprising mixing the at least one complexed conazole fungicide and the at least one de-complexing agent to obtain the composition.

14. A process for producing the composition as claimed in claim 9, comprising mixing the at least one complexed conazole fungicide and optionally other auxiliary ingredients to obtain a mixture, adding the de-complexing agent to obtained mixture to give a pre-mix, adding the one or more agrochemical ingredients to said premix to obtain a heterogeneous mix, and processing the heterogeneous mix.

15. A method of controlling unwanted pests comprising applying the composition of claim 1 to the pests or to their habitat.

16. A method of controlling unwanted pests comprising applying the composition of claim 9 v, to the pests or to their habitat.

17. A kit comprising a composition of: at least one complexed conazole fungicide; and at least one de-complexing agent; wherein the de-complexing agent is selected from polymeric surfactants, chelating agents, inorganic and organic salts, amino acids and peptides, wherein said amino acids and peptides do not contain sulphur.
